(19) United States
(12) Patent Application Publication
(10) Pub. No.: US 2026/0339250 A1
(43) Pub. Date: Oct. 29, 2026

(54) IMAGE FORMING APPARATUS, CONTROL METHOD, AND STORAGE MEDIUM

(71) Applicant: Konica Minolta, Inc., Tokyo (JP)

(72) Inventors: Kenichi Hayashi, Anjo-shi (JP); Takashi Nara, Kawagoe-shi (JP); Takumi Shirakuma, Tokyo (JP)

(73) Assignee: Konica Minolta, Inc., Tokyo (JP)

(21) Appl. No.: 19/552,131

(22) Filed: Feb. 27, 2026

(30) Foreign Application Priority Data
Feb. 27, 2025 (JP) 2025-030300

(51) Int. Cl. G03G 15/00; G03G 15/01

(52) U.S. Cl. CPC G03G 15/5008; G03G 15/0131; G03G 15/0189; G03G 2215/0135

(57) ABSTRACT

An image forming apparatus including: image bearing members on which toner images in respective colors are individually formed correspondingly to a plurality of colors; a belt that is disposed so as to face the image bearing members of the respective colors arranged along a conveyance direction and transfers a toner image obtained by superimposing the toner images of the respective colors onto a recording medium; image bearing member drivers configured to individually drive the image bearing members of the respective colors; a belt driver that conveys the belt; and a hardware processor that: detects outer peripheral speed fluctuation cycles in the image bearing members of the respective colors, and adjusts rotational speeds of the image bearing members of the respective colors so that a difference between the outer peripheral speed fluctuation cycles in the image bearing members of the respective colors is within a predetermined range.

### CROSS-REFERENCE TO RELATED APPLICATIONS

The entire disclosure of Japanese Patent Application No. 2025-030300 filed on Feb. 27, 2025 is incorporated herein by reference in its entirety.

### BACKGROUND OF THE INVENTION

### Technical Field

The present disclosure relates to an image forming apparatus, a control method, and a storage medium.

### Description of Related Art

A so-called tandem type image forming apparatus in which drums of respective colors corresponding to a plurality of colors are arranged side by side in a conveyance direction of a belt has been conventionally used. In this image forming apparatus, it is necessary to transfer the toner images formed on the drums of the respective colors onto the belt side in a superimposed manner at an appropriate timing. Therefore, it is necessary to rotate the drums of the respective colors in synchronism with each other.

On the other hand, the drum is a consumable item that is more likely to deteriorate than other components, and is generally replaced when it deteriorates. Therefore, eccentricity due to a clearance error is more likely to occur than in a case where the holding section of the drum is assembled without being removed. The eccentricity causes a cyclic speed fluctuation on the outer periphery of the drum even when the drum keeps rotating at a constant speed.

Hereinafter, the speed fluctuation occurring on the outer periphery of the drum is referred to as outer peripheral speed fluctuation.

FIG. 9 is a diagram illustrating an outer peripheral speed fluctuation in which a horizontal axis represents time and a vertical axis represents a numerical value corresponding to a speed of an outer periphery of the drum. A solid line L3 and a dotted line L4 indicate a case where the phase of the cyclic outer peripheral speed fluctuation is shifted by a half cycle.

The outer peripheral speed fluctuation of the eccentric drum has a pattern in which increase and decrease are repeated with one rotation of the drum as one cycle. The phase of the outer peripheral speed fluctuation in the drum of each color may vary to some extent. As illustrated in FIG. 9, when a phase shift of a half cycle occurs between the two drums, the speed difference between the outer peripheries becomes maximum, and color misregistration increases, which can cause a reduction in the quality of the formed image.

Therefore, the image forming apparatus of Japanese Unexamined Patent Publication No. H 09-146329 detects the phases of the outer peripheral speed fluctuations in the respective drums and rotates the respective drums to perform adjustment for matching the phases of the outer peripheral speed fluctuations.

### SUMMARY OF THE INVENTION

The drum transfers the toner with a slight speed difference at a position where the drum and the belt are closest to each other. Therefore, the drum is configured such that a lubricant is applied to an outer periphery surface thereof to reduce an electrostatic binding force with the belt, thereby maintaining the rotation at a target speed.

On the other hand, when deterioration or shortage of the lubricant occurs due to long-term use, a binding force from the belt to the drum increases, and a change occurs in the outer peripheral speed fluctuation cycle of the drum.

As a result, even when the phases of the outer peripheral speed fluctuations of the drums for the respective colors were matched, the speeds varied due to the mismatch of the cycles, and thus the reduction in image quality due to the color misregistration was not prevented.

It is an object of the present disclosure to improve the quality of a formed image.

To achieve at least one of the abovementioned objects, according to an aspect of the present invention, image forming apparatus reflecting one aspect of the present invention comprises:
image bearing members on which toner images in respective colors are individually formed correspondingly to a plurality of colors;
a belt that is disposed so as to face the image bearing members of the respective colors arranged along a conveyance direction and transfers a toner image obtained by superimposing the toner images of the respective colors onto a recording medium;
image bearing member drivers configured to individually drive the image bearing members of the respective colors;
a belt driver that conveys the belt; and
a hardware processor that:
detects outer peripheral speed fluctuation cycles in the image bearing members of the respective colors, and adjusts rotational speeds of the image bearing members of the respective colors so that a difference between the outer peripheral speed fluctuation cycles in the image bearing members of the respective colors is within a predetermined range.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of an image forming apparatus according to the present embodiment;

FIG. 2 is a functional block diagram illustrating a control structure of the image forming apparatus according to the present embodiment;

FIG. 3 is a view illustrating a schematic configuration of a lubricant application mechanism;

FIG. 4 is a circuit block diagram relating to the control of the drums of the respective colors and the drive roller for feeding the belt in the image forming apparatus;

FIG. 5 is a view of the belt, the color registration sensor, and determination marks for color registration correction as viewed from the left side of the page of FIG. 1;

FIG. 6 is an enlarged view of a determination mark for color registration correction formed in a non-image forming area of the belt when viewed from the same line of sight as in FIG. 5;

FIG. 7 is a diagram of a speed fluctuation detection pattern for detecting an outer peripheral speed fluctuation cycle in a drum of each color formed on a belt, viewed from the left side of the page of FIG. 1;

FIG. 8 is a diagram illustrating an example of fluctuations in the outer peripheral speed of the drum plotted with time on the horizontal axis and time intervals between detections of bar-like patterns of detection data on the vertical axis;

FIG. 9 is a diagram illustrating an outer peripheral speed fluctuation in a drum in which a difference between outer peripheral speed fluctuation cycles in two drums is within a predetermined range or the two drums coincide with each other but a phase difference occurs therebetween; and

FIG. 10 is a flowchart showing the drum drive control including the rotational speed adjustment for reducing the difference in the fluctuation of the outer peripheral speed fluctuation cycle in each color drum.

### DETAILED DESCRIPTION

Hereinafter, one or more embodiments of the present invention will be described with reference to the drawings. However, the scope of the invention is not limited to the disclosed embodiments.

Hereinafter, embodiment of the present disclosure will be described in detail with reference to the drawings.

### Overall Configuration of Image Forming Apparatus

The image forming apparatus 1 according to the present embodiment is a tandem-type color image forming apparatus that forms a color image on a sheet as a recording medium by an electrophotographic method.

The image forming apparatus 1 performs image formation on the basis of image data obtained by reading an image from a document or image data received from an external device.

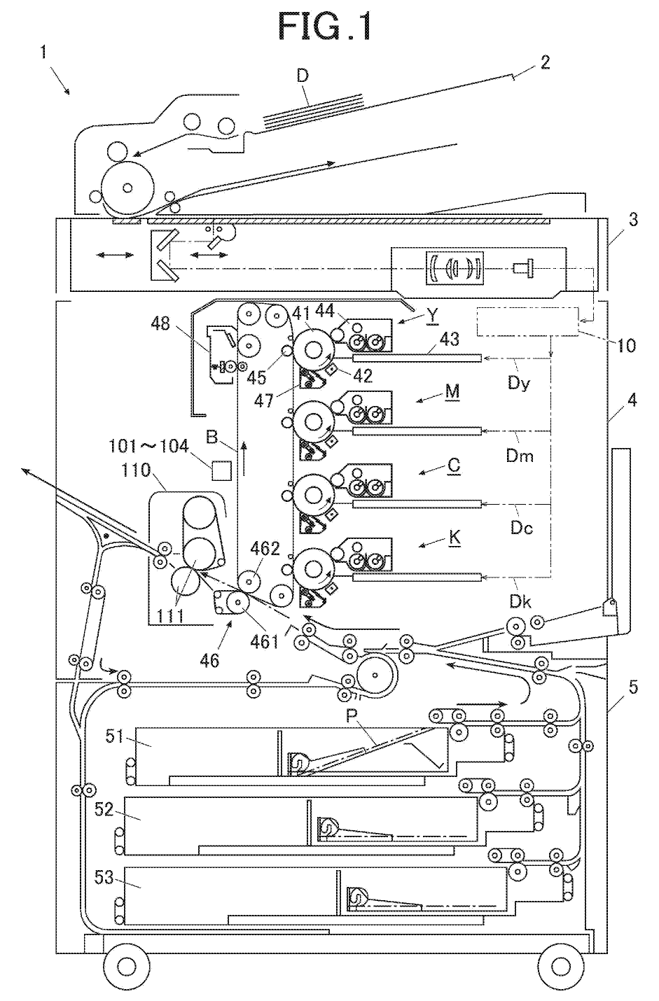

As shown in FIG. 1, the image forming apparatus 1 includes an automatic document conveyance section 2, a scanner section 3, an image forming section 4, and a sheet feed section 5.

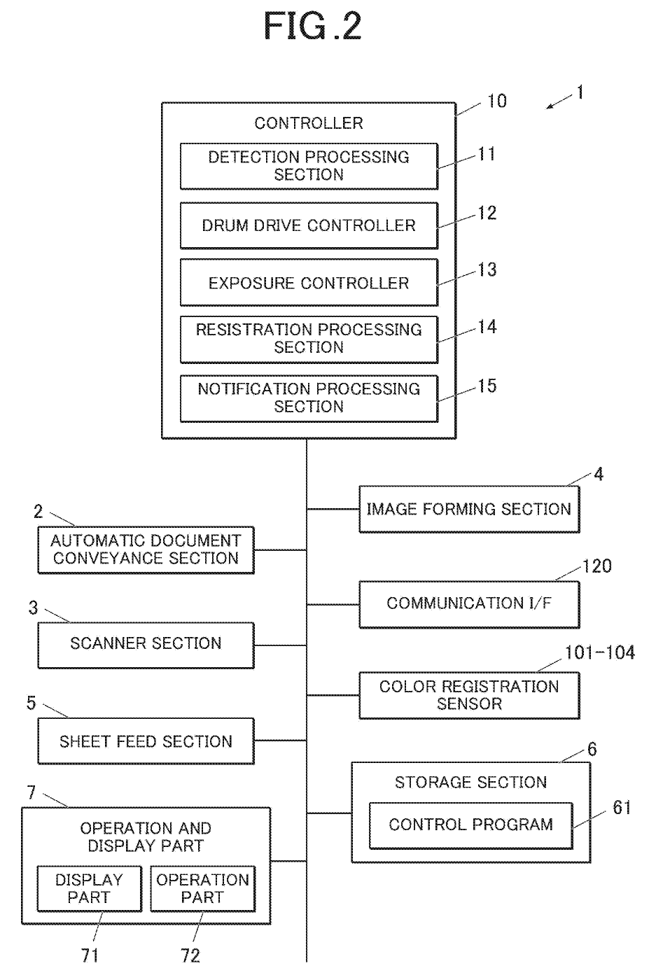

Furthermore, as illustrated in FIG. 2, the image forming apparatus 1 includes a storage section 6, an operation and display part 7, a controller 10 (hardware processor), and the color registration sensors 101 to 104.

### Automatic Document Conveyance Section and Scanner Section

The automatic document conveyance section 2 includes a placement tray on which the document D is placed, a conveyance mechanism for conveying the document D to a conveyance path, and a conveyance roller.

The scanner section 3 includes an optical system, such as a light source and a reflecting mirror. The scanner section 3 irradiates the document D conveyed through the conveyance path or the document D placed on the platen glass with a light source, and receives reflected light to perform reading. The scanner section 3 converts an image read by the received reflected light into an electrical signal and outputs the electrical signal to the controller 10.

### Image forming section

The image forming section 4 includes image forming sections Y, M, C, and K corresponding to four colors, a belt B, and a fixing device 110.

The image forming sections Y, M, C, and K form yellow, magenta, cyan, and black toner images, respectively, on drums 41 serving as image bearing members. Each of the drums 41 primarily transfers the toner image of each color of Y, M, C, and K formed on the outer periphery surface to the belt B.

Note that the configurations and the operations of the image forming sections Y, M, C, and K are the same in principle. Therefore, hereinafter, the configuration of the yellow image forming section Y and a series of image forming operations performed by the image forming section 4 will be described by way of example.

The drum 41 is a photosensitive drum made of an organic photoreceptor in which a photosensitive layer made of a resin containing an organic photoconductor is formed on the outer periphery surface of a cylindrical metal base. The drum 41 is rotationally driven in a counterclockwise direction in FIG. 1. Examples of the resin that forms the photosensitive layer include polycarbonate resin, silicone resin, polystyrene resin, acrylic resin, and methacrylic resin. Furthermore, the resin constituting the photosensitive layer may be an epoxy resin, a polyurethane resin, a vinyl chloride resin, a melamine resin, or the like.

The charging device 42 charges the photosensitive layer of the drum 41 to a constant potential using a charger.

The exposure device 43 exposes a non-image area of the drum 41 based on image data Dy from the controller 10. Thus, the charge on the exposure portion is removed, and an electrostatic latent image is formed on the image area of the drum 41.

The developing device 44 supplies developer, which is a developer, onto the electrostatic latent image formed on the drum 41 to form a yellow toner image on the drum 41.

The primary transfer roller (primary transfer section) 45 primary-transfers the yellow toner image formed on the drum 41 onto the belt B.

Similarly, the other image forming sections M, C, and K primarily transfer magenta, cyan, and black toner images to the belt B. Thus, the toner images in the respective colors of Y, M, C, and K are formed on the belt B in a superimposed manner.

The belt B is an intermediate transfer belt formed of a semiconductive endless belt. The belt B is looped over a plurality of rollers including a drive roller 462, and is conveyed clockwise in FIG. 1 as the rollers rotate. The belt B is brought close to or into contact with each of the opposing drums 41 by the primary transfer roller 45. A transfer current corresponding to the applied voltage flows through each of the primary transfer roller 45. As a result, the toner images developed on the surfaces of the drums 41 are successively primary-transferred onto the belt B by the primary transfer roller 45.

The secondary transfer device (secondary transfer section) 46 includes a secondary transfer roller 461 and a drive roller 462 that rotationally drives the belt B. The secondary transfer device 46 secondarily transfers the toner image primarily transferred onto the belt B, onto a sheet P. The secondary transfer roller 461 comes into pressure contact with the belt B, and the drive roller 462 forms one of a plurality of rollers around which the belt B is wound. The secondary transfer device 46 forms, with the secondary transfer roller 461 and the drive roller 462 that form a pair, a transfer nip through which the sheet P passes. The toner image on the belt B is secondarily transferred, at the transfer nip, to a sheet P conveyed from one of sheet feed trays 51 to 53 of a sheet feed section 5.

The secondary transfer roller 461 is supported by an actuator (not shown) which separates the secondary transfer roller from the belt B and the drive roller 462. On the belt B, determination marks 109 for color registration correction and speed fluctuation detection patterns 121 may be formed by the image forming section 4. In this case, the secondary transfer roller 461 is separated from the belt B by an actuator so that the determination marks 109 and the like are not transferred from the belt B.

A cleaning device 47 for residual toner is provided on the downstream side in the rotation direction of the transfer position of the drum 41 to the belt B.

The cleaning device 47 removes residues such as residual toner and paper dust remaining on the surface of the drum 41 after the primary transfer. The cleaning device 47 brings a plate-like or sheet-like cleaning blade made of an elastic body such as polyurethane rubber into contact with the drum 41. The cleaning device 47 employs a so-called blade cleaning method.

Further, a cleaning device 48 for residual toner is provided on the downstream side of the transfer position on the belt B in the conveyance direction. The cleaning device 48 removes a residue remaining on the belt B after the secondary transfer.

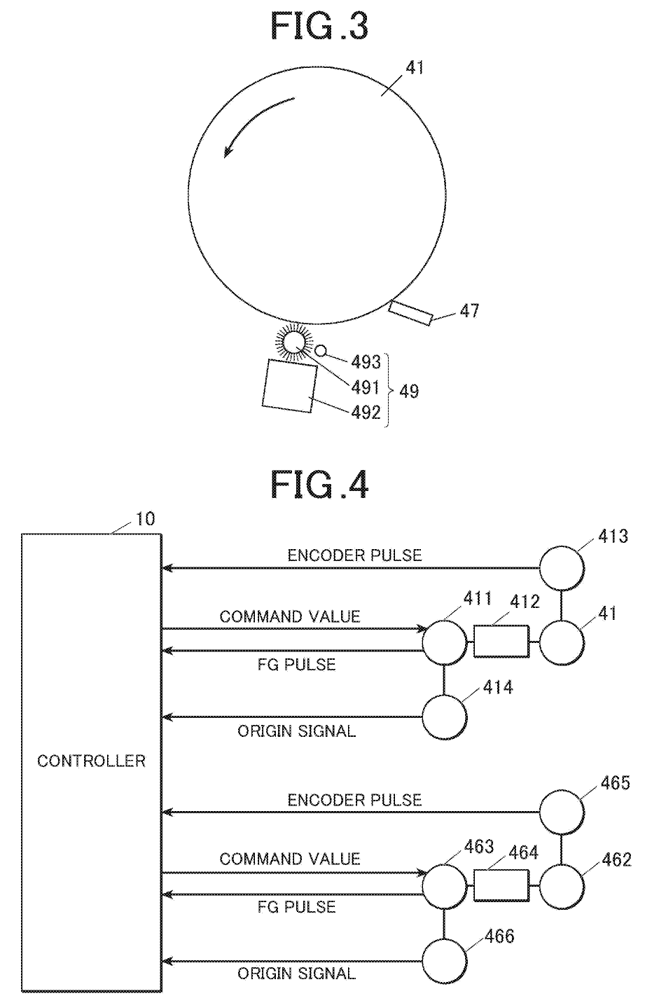

As illustrated in FIG. 3, a lubricant application mechanism 49 is arranged on the downstream side in the conveyance direction from the transfer position of the drum 41 to the belt B and on the front of the cleaning device 47. Lubricant application mechanism 49 is a lubricant applicator for applying a lubricant to drum 41. Lubricant application mechanism 49 includes brush roller 491, solid lubricant 492, and brush cleaning member 493.

Brush roller 491 is driven by a motor to rotate while being in contact with both solid lubricant 492 and drum 41. Thus, brush roller 491 supplies lubricant particles scraped from solid lubricant 492 to drum 41, and spreads and applies the lubricant particles.

As the solid lubricant 492, a material capable of reducing the adhesive force between the drum 41 and the belt B by lowering the surface energy by coating is selected. Examples thereof include fatty acid metal salts, fluorine-based resins, and mixtures thereof. In particular, fatty acid metal salts are preferable. As the fatty acid of the fatty acid metal salt, a linear hydrocarbon is preferable. For example, myristic acid, palmitic acid, stearic acid, oleic acid and the like are preferable, and stearic acid is more preferable. Examples of the metal include lithium, magnesium, calcium, strontium, zinc, cadmium, aluminum, cerium, titanium, and iron. Among these, zinc stearate, magnesium stearate, aluminum stearate, iron stearate and the like are preferable.

The brush cleaning member 493 is provided in contact with the brush roller 491. The brush cleaning member 493 collects the toner collected from the drum 41 by the brush roller 491 before the toner reaches the solid lubricant 492.

### Fixing Device

The fixing device 110 includes a fixing roller pair 111 and performs fixing processing for fixing the toner image transferred onto the sheet P. The fixing roller pair 111 forms a fixing nip through which the sheet P passes between the pair of rollers. The fixing device 110 heats and presses, at the fixing nip, the sheet P onto which the toner image has been transferred, to fix the image onto the sheet P.

The image forming section 4 applies heat and pressure to the sheet P, on which the toner images in the respective colors have been secondarily transferred, by the fixing device 110, and then ejects the sheet P to the outside of the apparatus through a predetermined conveyance path.

### Drum driver and Belt driver

FIG. 4 is a circuit block diagram relating to control of the drums 41 for the respective colors and the drive roller 462 for feeding the belt B in the image forming apparatus 1. Note that configurations related to control of the respective drums 41 in the image forming sections Y, M, C, and K are all the same, and only one set is illustrated and the others are omitted in FIG. 4.

As illustrated in FIG. 4, a drive motor 411 that rotationally drives the drum 41 is controllably connected to the controller 10. The drum 41 is connected to a drive shaft of the drum drive motor 411 via a transmission mechanism 412 including a speed reducer. The drum drive motor 411 and the transmission mechanism 412 constitute a drum driver as an image bearing member driver, and their operations are controlled by the controller 10.

Furthermore, a belt drive motor 463 that rotationally drives the drive roller 462 is controllably connected to the controller 10. The drive roller 462 is connected to a drive shaft of the belt drive motor 463 via a transmission mechanism 464 including a speed reducer. The belt drive motor 463 and the transmission mechanism 464 constitute a belt driver, and their operation is controlled by the controller 10.

Both the drum drive motor 411 and the belt drive motor 463 are DC brushless motors. The controller 10 individually transmits, to each of the drive motor 411 and 463, a PWM signal for controlling the speed and torque of each of the drive motor 411 and 463 as a command value. Note that PWM is an abbreviation of PulseWidthModulation. Each of the drive motors 411 and 463 is driven based on a command received from the controller 10, and the drum 41 or the drive roller 462 is rotated by this driving.

Both the drum drive motor 411 and the belt drive motor 463 output a specified number of FG pulse signals per rotation to the controller 10 at constant intervals. The drive motors 411 and 463 are provided with origin sensors 414 and 466, respectively, which output origin signals at predetermined shaft angles determined as the origins of the output shafts. The origin sensor 414 and 466 perform output once per rotation of the output shafts of the drive motor 411 and 463.

In addition, the drum 41 and the drive roller 462 are provided along with encoders 413 and 465 as phase sensors for detecting a predetermined phase. The encoder 413 and 465 output pulse signals at constant intervals in accordance with their respective rotations.

The controller 10 performs feedback control of each of the drive motors 411 and 463 on the basis of the FG pulse signal and the encoder pulse signal.

Note that as the drive motor 411 and 463, other motors whose operation and rotational speeds can be controlled may be used. In addition, another well-known configuration capable of detecting a rotation amount or a rotation angle may be used as the rotation amount of the drive motor 411 and 463.

### sheet feed section

The sheet feed section 5 includes a plurality of sheet feed trays 51 to 53, and different types of sheet P are stored in the respective sheet feed trays 51 to 53. The sheet feed section 5 feeds the sheet P accommodated in a predetermined conveyance path to the image forming section 4.

### operation and display part

The operation and display part 7 includes a liquid crystal display (LCD) having a touch screen, for example, and functions as a display part 71 and an operation part 72. An organic EL display may be used as the display part 71 of the operation and display part 7.

The display part 71 displays various kinds of operation screens, operating status of the respective functions, and so forth in accordance with display control signals received from the controller 10. In addition, a touch operation by the user is received, and an operation signal is output to the controller 10.

The operation part 72 includes various kinds of operation keys such as a numeric keypad and a start key, accepts various kinds of input operation by a user, and outputs an operation signal to the controller 10. A user can operate the operation and display part 7 to make settings related to image formation, such as image quality setting, magnification setting, application setting, output setting, and sheet setting. In addition, the user can also operate the operation and display part 7 to give a sheet conveyance instruction, stop the apparatus, and the like.

Note that the display part 71 and the operation part 72 may be separated and independent from each other.

### Color Registration Sensor

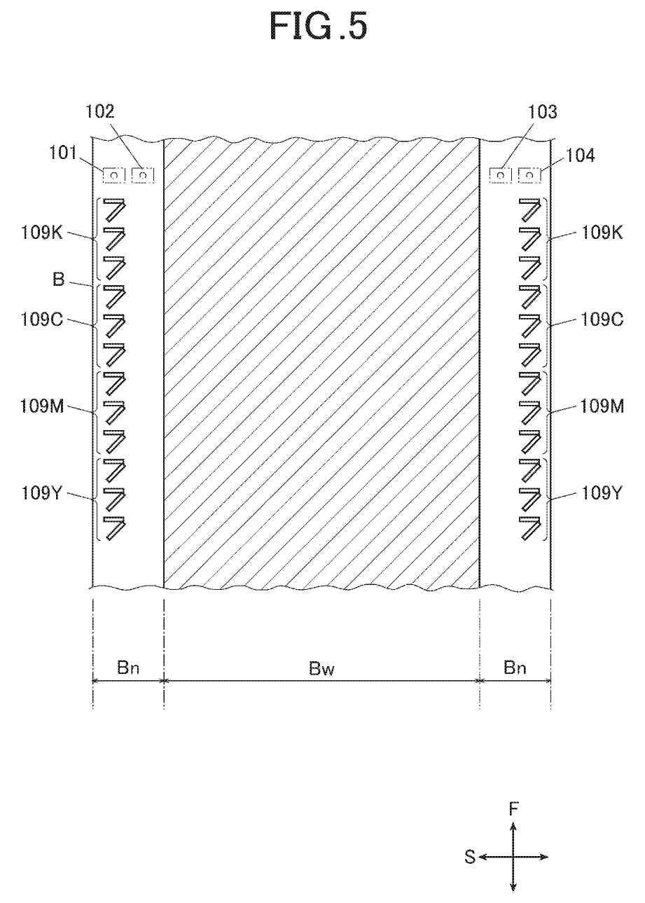

FIG. 5 is a view of the belt B and the color registration sensor 101 to 104 as viewed from the left side of the page of FIG. 1. Hereinafter, the color registration sensor 101 to 104 are abbreviated as the sensor 101 to 104. A symbol S indicates a main scanning direction which is a direction orthogonal to the conveyance direction of the belt B, and a symbol F indicates a sub-scanning direction along the conveyance direction of the belt B.

In FIG. 5, the belt B is conveyance to the upper side of the paper surface.

As illustrated in FIG. 1, the sensor 101 to 104 are disposed on the upstream side of the cleaning device 48 in the conveyance route of the belt B. Furthermore, as illustrated in FIG. 5, the sensor 101 to 104 are arranged side by side along the main scanning direction S. Further, the sensor 101 and 102 and the sensor 103 and 104 are disposed so as to be opposed to both end portions of the belt B in the main scanning direction S, respectively. The sensor 101 and 102 and the sensor 103 and 104 are arranged so as to face non-image forming areas Bn on both outer sides of the image forming area Bw of the belt B.

FIG. 5 illustrates a case where the row of the determination marks 109Y to 109K for color registration correction is formed on the passing line of sensor 101 and sensor 104. However, the determination marks 109 may be arranged in one or more rows and may be formed at the detection positions of any of the sensor 101 to 104. Note that hereinafter, the determination marks 109Y to 109K will be referred to as the determination marks 109 when they are described without being distinguished by color.

Three of each of the determination marks 109Y to 109K are formed side by side in a row at uniform intervals along the sub-scanning direction. Note that the number of each of the determination marks 109Y to 109K may be one, two, or four or more.

The sensor 101 to 104 are also used for reading a speed fluctuation detection pattern 121 for detecting an outer peripheral speed fluctuation cycle of the drum 41 of each color described later. Therefore, four sensor 101 to 104 are prepared. However, for the purpose of only reading the determination marks 109 for color registration correction, one or more sensor 101 to 104 may be provided.

The determination marks 109Y to 109K may be divided into four rows for each color and formed at the respective reading positions of the sensor 101 to 104.

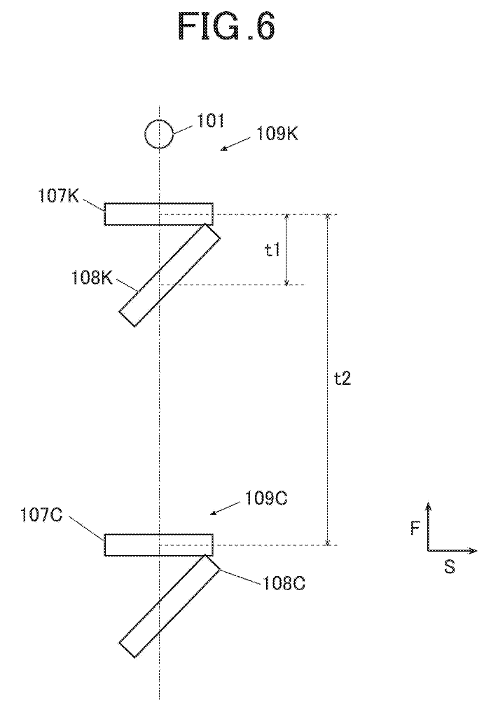

FIG. 6 is an enlarged view of the determination marks 109K and 109C formed in the non-image forming region Bn by the image forming section 4, as viewed from the same line of sight as in FIG. 5.

The determination marks 109K and C for color registration correction each include a bar-like first determination section 107K and C and a second determination section 108K and C. Note that although not illustrated in FIG. 6, the determination marks 109M and Y also each include a first determination section and a second determination section.

In the following description, the first determination sections 107K and C will be referred to as the first determination sections 107 when described without differentiating between the colors. Similarly, the second determination sections 108K and C will be referred to as the second determination section 108 when described without differentiating between the colors.

As illustrated in FIG. 6, the first determination section 107 has a strip shape parallel to the main scanning direction S. The second determination section 108 has a strip shape extending in an oblique direction that is a combination of the main scanning direction S and the sub-scanning direction F.

When the belt B is conveyed at a specified speed, the first determination section 107 and the second determination section 108 are sequentially detected by, for example, the sensor 101. An elapsed time from the detection of the first determination section 107 to the detection of the second determination section 108 is defined as t1. In this case, when the determination mark 109 is displaced in the main scanning direction S, the elapsed time t1 increases or decreases with respect to a case where the determination mark 109 is located at an appropriate position. Then, depending on whether the elapsed time t1 increases or decreases, it is possible to determine whether the deviation of the determination mark 109 occurs to one side or the other side in the main scanning direction S. Further, the amount of deviation in the main scanning direction S can be specified by the length of the elapsed time t1.

Further, by detecting each of the first determination sections 107 of the two determination marks 109 arranged in the sub-scanning direction in different colors, it is possible to obtain the misregistration in the sub-scanning direction F for each color. Note that although the determination marks 109K and the determination marks 109C are illustrated in FIG. 6, the same applies to other colors.

An elapsed time from the detection of the first determination section 107K to the detection of the first determination section 107C is defined as t2. When there is a shift between the two determination marks 109 in the sub-scanning direction F, the elapsed time t2 increases or decreases with respect to the case where the two determination marks 109 are located at appropriate positions. Then, based on whether the elapsed time t2 increases or decreases, it is possible to determine whether each determination mark 109 is shifted to one side or the other side in the sub-scanning direction F. Further, the amount of deviation in the sub-scanning direction F can be specified by the magnitude of the timing difference of the elapsed time t2 with respect to the appropriate value.

Note that as described above, it is also possible to form the determination marks 109 for the respective colors of Y, M, C, and K and individually detect them by the respective sensors 101 to 104. In this case, it is possible to specify the deviation amount for each color in the sub-scanning direction F according to the magnitude of the difference in timing detected by the first determination section 107 in each of the sensors 101 to 104.

The deviation for each color in the main scanning direction S is the same as the case described above.

### Control System Of Image Forming Apparatus

The storage section 6 includes a hard disk drive (HDD), a nonvolatile semiconductor memory, and the like. As shown in FIG. 2, the storage section 6 stores various programs such as a control program 61 and various data such as image data and setting information used for image formation.

The communication I/F 120 includes a network interface card (NIC) and a modem, and transmits and receives data to and from a PC and a peripheral device.

The controller 10 includes a CPU, RAM, ROM, and the like. The CPU develops various programs stored in the ROM or the storage section 6 into the RAM. Thus, the CPU integrally controls the automatic document conveyance section 2, the scanner section 3, the image forming section 4, the sheet feed section 5, the storage section 6, the operation and display part 7, and the like.

For example, the controller 10 performs various types of image processing on image data acquired from the scanner section 3 or an external personal computer or the like via the communication I/F120. Furthermore, the controller 10 outputs the image data Dy, Dm, Dc, and Dk of the respective colors of YMCK generated by the image processing to the image forming section 4. Further, the controller 10 controls the operation of the image forming section 4 to form an image on the sheet P.

Furthermore, the controller 10 implements each function configuration illustrated in FIG. 2 by the CPU executing the control program 61. That is, the controller 10 functions as a detection processing section 11, a drum drive controller 12 as an image bearing member drive controller, an exposure controller 13, a registration processing section 14, and a notification processing section 15. Each of these function components will be described.

### Detection Processing Section

The detection processing section 11 executes control for detecting an outer peripheral speed fluctuation cycle in the drum 41 of each color of Y, M, C, and K. The detection processing section 11 functions as a speed fluctuation cycle detection means in cooperation with the image forming section 4 and the sensors 101 to 104.

As described above, the drum 41 may cause an outer peripheral speed fluctuation with a cycle that matches a rotation cycle due to eccentricity or the like. Furthermore, the outer peripheral speed fluctuation cycle of the drum 41 may change due to, for example, a temporal change in the electrostatic binding force with the belt B.

The detection processing section 11 detects the cyclic outer peripheral speed fluctuation and the cycle thereof by the following control and processing with respect to the drum 41 of each color.

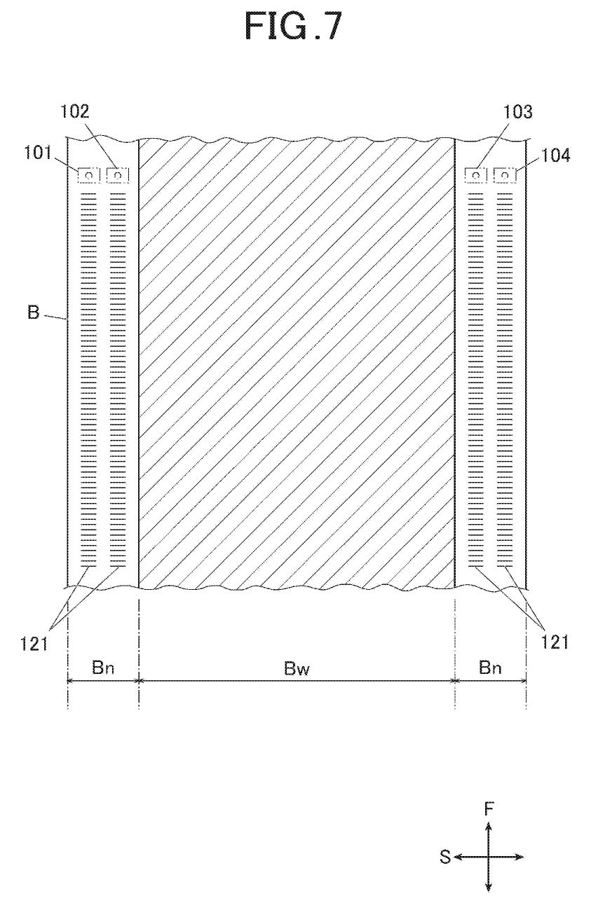

FIG. 7 is a view of a speed fluctuation detection pattern 121 for detecting the outer peripheral speed fluctuation cycle of the drum 41 of each color formed on the belt B as viewed from the left side of the paper surface of FIG. 1.

The detection processing section 11 controls the image forming section Y, M, C, and K to form the speed fluctuation detection patterns 121 of the respective colors in the non-image forming areas Bn of the belt B. In the speed fluctuation detection pattern 121, bar-shaped patterns along the main scanning direction S are arranged in the sub-scanning direction.

When the bar-shaped pattern is formed, laser exposure is performed on each of the drums 41 at a constant angular interval at a target rotational speed at the time of image formation by the output of the encoder 413. The electrostatic latent image of the bar-like pattern is formed at least for one rotation of the drum 41, more preferably for a plurality of rotations.

After the development of the drum 41, the rod-like speed fluctuation detection pattern 121 is transferred onto the belt B at an interval based on the outer peripheral speed fluctuation of the drum 41.

The bar-shaped patterns are originally formed at uniform intervals in the sub-scanning direction, but when fluctuation of the outer peripheral speed of the drum 41 exists, the bar-shaped patterns are transferred to the belt B at intervals corresponding to the fluctuation.

The detection processing section 11 causes each of the sensors 101 to 104 to read the speed fluctuation detection pattern 121 of each color while conveyance the belt B at a constant speed.

A time interval for detecting the bar-shaped pattern of the speed fluctuation detection pattern 121 by each of the sensors 101 to 104 is obtained, and data arranged in order is stored in the storage section 6. Data formed of the enumeration of the time intervals becomes detection data of the outer peripheral speed fluctuation in the drum 41 of each color.

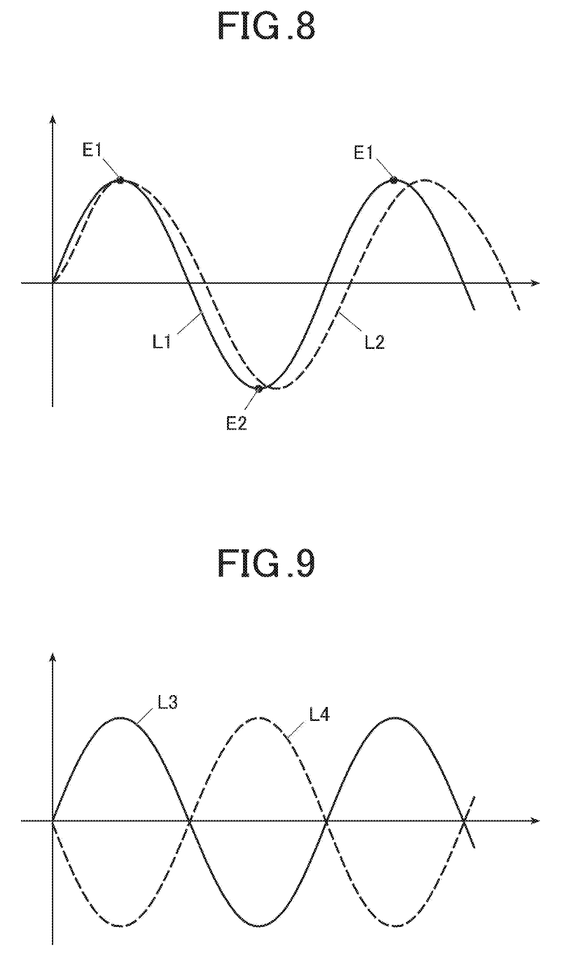

FIG. 8 is a diagram illustrating an example of the outer peripheral speed fluctuation in the drum 41 plotted with time on the horizontal axis and a detection time interval of a bar-like pattern on the vertical axis. The detection time interval of the bar-shaped pattern is a numerical value proportional to the speed of the outer periphery of the drum 41. Therefore, a change in the value of the detection time interval of the series of bar-like patterns indicates a fluctuation in the outer peripheral speed of the drum 41.

A symbol L1 of FIG. 8 is a line diagram in a case where a fluctuation occurs in the outer peripheral speed fluctuation cycle, and a symbol L2 is a line diagram for comparison in a case where a fluctuation does not occur in the outer peripheral speed fluctuation cycle. FIG. 8 illustrates a case where the outer peripheral speed fluctuation cycle of the drum 41 is shortened by the binding force to the belt B.

The detection processing section 11 obtains the maximum value E1 and the minimum value E2 from the detection date of the outer peripheral speed fluctuation in the drum 41, and calculates the outer peripheral speed fluctuation cycle from the time interval between these values.

### Drum Drive Controller

The drum drive controller 12 adjusts the rotational speed of the drum 41 of each color so that the difference between the outer peripheral speed fluctuation cycles of the drums 41 of each color is within a predetermined range. More preferably, the drum drive controller 12 makes the outer peripheral speed fluctuation cycles of the drums 41 of the respective colors coincide with each other. The predetermined range described above may be arbitrarily settable from an input section such as the operation part 72.

For example, the drum drive controller 12 may perform adjustment so that the difference between the outer peripheral speed fluctuation cycles of the drums 41 of the respective colors is within a predetermined range by approximating the values of the other drums 41 with reference to the standard outer peripheral speed fluctuation cycle of any one of the drums 41.

Alternatively, the adjustment may be performed so that the difference between the outer peripheral speed fluctuation cycles of the drums 41 of the respective colors is within a predetermined range by approximating the outer peripheral speed fluctuation cycles of all the drums 41 to the cycle at the target rotational speed of the drum 41 during the image formation.

The outer peripheral speed fluctuation cycle of the drum 41 can be adjusted by increasing or decreasing the rotational speed of the drum 41. When the rotational speed of the drum 41 is increased, the outer peripheral speed fluctuation cycle of the drum 41 can be shortened. When the rotational speed of the drum 41 is lowered, the outer peripheral speed fluctuation cycle of the drum 41 can be lengthened.

The adjustment to increase or decrease the rotational speed of the drum 41 is performed by one of the following (1) and (2). (1) The drum drive controller 12 calculates a ratio fc/fv of the outer peripheral speed fluctuation cycle fc in each drum 41 to the cycle fv at the target rotational speed of the drum 41. Next, the drum drive controller 12 multiplies the current rotational speed of the drum 41 by the calculated ratio fc/fv. Thus, the outer peripheral speed fluctuation cycle of each drum 41 can be brought close to the cycle at the target rotational speed of the drum 41 during image formation, so that the difference between the outer peripheral speed fluctuation cycles of the drums 41 of the respective colors falls within a predetermined range.

Note that the drum drive controller 12 may multiply the current rotational speed of the drum 41 by a numerical value obtained by further multiplying the calculated ratio fc/fv by a coefficient.

(2) The drum drive controller 12 compares the outer peripheral speed fluctuation cycle fc of each drum 41 with the cycle fv at the target rotational speed of the drum 41 during image formation.

Next, when the outer peripheral speed fluctuation cycle fc in each drum 41 is short, the rotational speed of the drum 41 is decelerated to the current rotational speed of the drum 41 by a specified value or at a specified ratio.

In addition, if the outer peripheral speed fluctuation cycle fc in each drum 41 is long, the current rotational speed of the drum 41 is increased by a specified value or a specified ratio.

Accordingly, it is possible to adjust the difference between the outer peripheral speed fluctuation cycles of the drums 41 of the respective colors to be within a predetermined range.

The drum drive controller 12 may perform the rough adjustment of the rotational speed of the drum 41 not based on the magnitude of the difference between the cycle fc and the cycle fv, as in (2).

In addition, the drum drive controller 12 may perform the fine adjustment of the rotational speed of the drum 41 by (1) after performing (2) in advance.

Regardless of whether the drum drive controller 12 performs (1) or (2), it is preferable that the detection processing section 11 detects the outer peripheral speed fluctuation cycle of each drum 41 again after the adjustment. In this case, when the difference between the outer peripheral speed fluctuation cycles of the drums 41 of the respective colors does not fall within the predetermined range, readjustment of the rotational speeds of some or all of the drums 41 is executed.

Furthermore, when adjusting the rotational speed of the drum 41, the drum drive controller 12 sets a command value for the encoder 413 and performs the adjustment while monitoring the encoder 413. In particular, in the case of the adjustment (1), the drum drive controller 12 adjusts the rotational speed of the drum 41 by feedback control based on the output of the encoder 413.

Further, the drum drive controller 12 performs phase matching of the outer peripheral speed fluctuation cycles of the drums 41 of the respective colors after the adjustment for causing the difference between the outer peripheral speed fluctuation cycles of the drums 41 of the respective colors to be within a predetermined range.

FIG. 9 is a diagram illustrating outer peripheral speed fluctuations of two drums 41 in which a difference between outer peripheral speed fluctuation cycles of the two drums 41 is within a predetermined range or the two drums 41 coincide with each other but a phase difference occurs therebetween. In this example, the outer peripheral speed fluctuation of one drum 41 is illustrated by a line diagram L3, and the outer peripheral speed fluctuation of the other drum 41 is illustrated by a line diagram L4. A phase difference of a half cycle occurs between the line diagram L3 and the line diagram L4. Note that an allowable value is set for the phase difference, and when the phase difference exceeds the allowable value, the drum drive controller 12 executes the phase matching.

The drum drive controller 12 obtains the maximum value and the minimum value of the outer peripheral speed fluctuation of the drum 41, and obtains the phases at these values. The phases of the local maximum value and the local minimum value can be acquired by recording the output of the encoder 413 when the speed fluctuation detection pattern 121 is formed. The drum drive controller 12 specifies the phases of the maximum value and the minimum value during the outer peripheral speed fluctuation by collating with the record of the output of the encoder 413. In addition, when the drum drive controller 12 specifies the phases of the local maximum value and the local minimum value, it is also possible to obtain the phase of a node or an antinode in the outer peripheral speed fluctuation of the drum 41.

Therefore, the drum drive controller 12 can obtain the phases of the nodes or antinodes of the drums 41 of the respective colors and calculate the phase differences therebetween.

In a case where the phase of any one of the drums 41 is advanced, the rotation of the drum drive motor 411 is temporarily stopped or decelerated, and then returned to the original speed. Thus, the phase can be delayed.

In a case where the phase of any of the drums 41 is delayed, the rotation is returned to the original speed after the temporary acceleration of the rotation of the drum drive motor 411. Thus, the phase can be advanced.

### Exposure controller

The exposure controller 13 controls the exposure device 43 for each color to adjust the timing of laser writing during image formation.

A target rotational speed of the drum 41 during image formation is set to a specified value. In principle, the exposure controller 13 determines the operation timing of the exposure device 43 in accordance with a specified value of the target rotational speed.

When the drum drive controller 12 performs the rotational speed adjustment for making the difference between the outer peripheral speed fluctuation cycles of the drums 41 fall within the predetermined range, it is also necessary to adjust the operation timing of the exposure device 43.

This is because the arrival time from the exposure position on the outer periphery surface of the exposure device 43 to the transfer position to the belt B varies (fluctuates) depending on the rotational speed of the drum 41.

Therefore, the exposure controller 13 calculates a new arrival time based on the arrival time of the drum 41 at the target rotational speed for image formation and the increase/decrease rate of the rotational speed of the drum 41. The exposure controller 13 adjusts the operation timing of the exposure device 43 based on the amount of increase or decrease in the new arrival time relative to the original arrival time.

In this case, the amount of increase or decrease in the new arrival time based on the rotational speed adjustment for setting the difference in the outer peripheral speed fluctuation cycle of the drum 41 within the predetermined range is referred to as a "first adjustment value".

Further, as described above, the drum drive controller 12 performs the phase matching of the outer peripheral speed fluctuation cycle in the drum 41. The exposure controller 13 also needs to adjust the operation timing of the exposure device 43 for this phase matching.

The exposure controller 13 acquires, from the drum drive controller 12, the amount of phase adjustment by phase matching of the drum 41. Next, the exposure controller 13 calculates the adjustment time based on the ratio of the adjustment amount to the phase of one cycle of the outer peripheral speed fluctuation cycle of the drum 41 and the outer peripheral speed fluctuation cycle.

The adjustment time based on the phase matching of the drum 41 in this case is referred to as a "second adjustment value".

The exposure controller 13 adjusts the writing timing with the first and second adjustment values in accordance with the rotational speed adjustment for matching the outer peripheral speed fluctuation cycles and the phase matching.

### Registration Processing Section

The registration processing section 14 performs registration processing after the drum drive controller 12 has performed rotational speed adjustment for making the difference between the outer peripheral speed fluctuation cycles of the respective drums 41 fall within a predetermined range. This registration processing is preferably performed after the adjustment of the rotational speed of each drum 41 and after the adjustment of the laser writing timing by the exposure controller 13.

After each adjustment, the registration processing section 14 controls the image forming section 4 of each color to form the determination mark 109 of FIG. 5 in the non-image forming region Bn of the belt B. Then, the registration processing section 14 detects the color misregistration in the main scanning direction and the sub-scanning direction of each color of Y, M, C, and K based on the detection of the sensors 101 and 104.

The registration processing section 14 specifies the amounts of color misregistration of the respective colors in the main scanning direction S and the sub-scanning direction F by detecting the elapsed times t1 and t2 described above. Furthermore, the registration processing section 14 reduces the amount of color misregistration by controlling the laser in the exposure device 43 for each color.

The registration processing section 14 reduces the color misregistration in the sub-scanning direction F by adjusting the shaft angle of the drum 41 at which the laser writing is started.

The registration processing section 14 reduces the color misregistration in the main scanning direction S by adjusting the emission start timing in each laser scanning.

### Notification Processing Section

The notification processing section 15 executes notification processing according to the number of times of execution of adjustment of the rotational speed of the drum 41 of each color for making the difference in the outer peripheral speed fluctuation cycle by the drum drive controller 12 fall within a predetermined range.

The notification processing section 15 counts the number of times of execution of the adjustment of the rotational speed of the drum 41 of each color for making the difference between the outer peripheral speed fluctuation cycles fall within the predetermined range. The adjustment of the rotational speed of the drum 41 may be repeated a plurality of times until an appropriate outer peripheral speed fluctuation cycle is reached. However, even in such a case, the notification processing section 15 counts a time until an appropriate outer peripheral speed fluctuation cycle comes as one time.

The notification processing section 15 stores the count value in the storage section 6 and monitors whether or not the count value reaches a predetermined threshold value. Next, when the count value reaches a threshold value, the notification processing section 15 notifies, with the display part 71, that the specific drum 41 is close to the end of its life or the like. The content of the notification processing may be an instruction prompting replacement of the drum 41. In addition, the notification process is not limited to the display of the display part 71, and notification may be performed by providing a sound output section or a lamp.

In addition, the threshold value of the count value for executing the notification process may be arbitrarily set from the operation part 72.

### Drum Drive Control

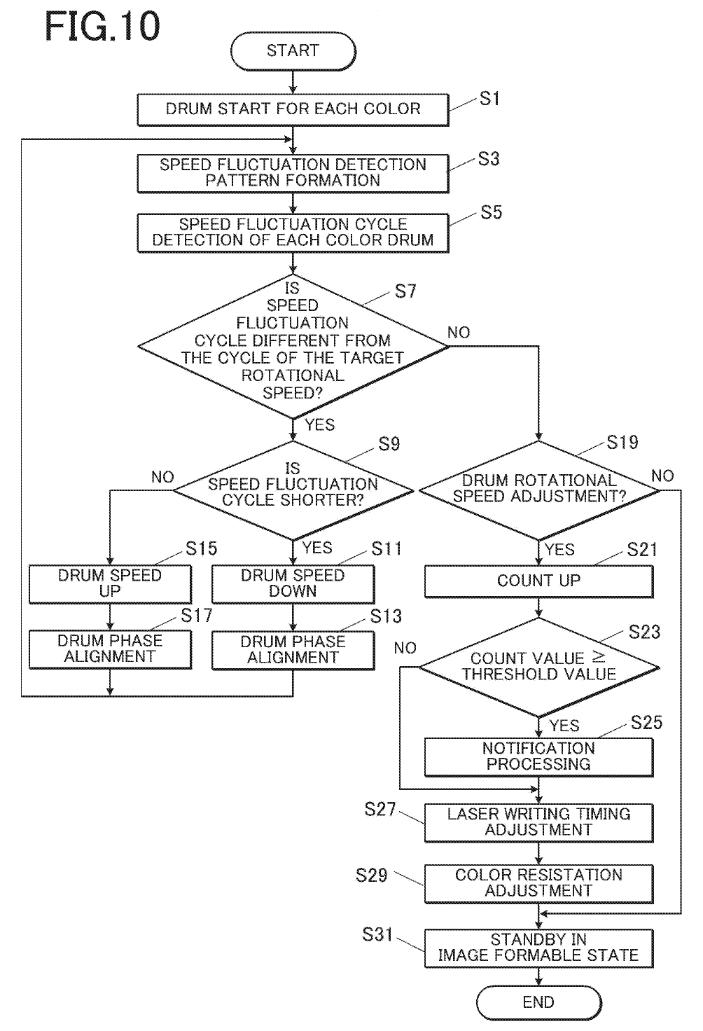

Drum drive control including rotational speed adjustment for making the difference in fluctuation of the outer peripheral speed fluctuation cycles in the drums 41 of the respective colors fall within a predetermined range will be described with reference to the flowchart of FIG. 10. This drum drive control is implemented by the CPU of the controller 10 executing the control program 61. Furthermore, the drum driving control implements a suitable control method for the image forming apparatus 1.

Note that this drum drive control is executed during non-execution of a print job including the time of activation of the image forming apparatus 1 or between pages of a print job.

The detection processing section 11 starts the drum 41 of each color at the target rotational speed (S1).

Furthermore, the detection processing section 11 performs exposure and developing of the speed fluctuation detection pattern 121 for at least one full turn on the drum 41 of each color. Next, the speed fluctuation detection pattern 121 is transferred onto the non-image forming area Bn of the belt B (S3).

Next, the detection processing section 11 reads the speed fluctuation detection pattern 121 of the belt B by the sensor 101 to 104. Then, an outer peripheral speed fluctuation of the drum of each color is detected from an interval between the bar-like patterns of the speed fluctuation detection patterns 121. The detection processing section 11 obtains the phases of the nodes or antinodes of the cyclic outer peripheral speed fluctuation and detects the cycle of the outer peripheral speed fluctuation (S5).

The drum drive controller 12 compares the outer peripheral speed fluctuation cycle of the drum 41 of each color with the cycle of the target rotational speed (S7).

When the difference between the outer peripheral speed fluctuation cycle of any of the drums 41 and the target rotational speed cycle is equal to or greater than the allowable value, the drum drive controller 12 proceeds to S9.

Further, when the difference between the outer peripheral speed fluctuation cycle and the target rotational speed cycle in all the drums 41 is within the allowable value, the drum drive controller 12 advances the process to S19.

In S9, when the drum drive controller 12 determines that the outer peripheral speed fluctuation cycle of the drum 41 is shorter than the target rotational speed cycle, the processing proceeds to S11.

In the S11, the drum drive controller 12 reduces the rotational speed of the drum drive motor 411 by a predetermined amount.

Then, the drum drive controller 12 performs phase matching (phase alignment) of the outer peripheral speed fluctuation cycle in the drum 41 whose rotational speed has been adjusted (S13). The phase matching is executed with standard to a predetermined phase of the drum 41.

Then, the drum drive controller 12 returns the process to S3.

On the other hand, in S9, when the drum drive controller 12 does not determine that the outer peripheral speed fluctuation cycle of the drum 41 is shorter than the target rotational speed cycle, the process proceeds to S15.

In the S15, the drum drive controller 12 increases the rotational speed of the drum drive motor 411 by a predetermined amount.

Then, the drum drive controller 12 performs phase matching (phase alignment) of the outer peripheral speed fluctuation cycle in the drum 41 whose rotational speed has been adjusted (S17). Also in this case, the phase matching is executed with standard to any one of the predetermined phases of the drum 41.

Then, the drum drive controller 12 returns the process to S3.

When the process is returned from S13 or S17 to S3, the detection processing section 11 forms the speed fluctuation detection pattern 121 again and detects the outer peripheral speed fluctuation cycle (S5).

Then, the drum drive controller 12 re-determines whether or not the difference between the cycle of the outer peripheral speed fluctuation and the cycle of the target rotational speed in the drum 41 of each color is within the predetermined range by the immediately previous adjustment (S7).

Then, when the difference does not become within the predetermined range, the processing of S9˜ S17 and S3˜ S7 is repeated again.

On the other hand, when the process proceeds from S7 to S19, the notification processing section 15 determines whether adjustment of the rotational speed by the drum drive controller 12 is to be executed (S19).

Then, when the adjustment of the rotational speed has not been performed, the process proceeds to S31.

Furthermore, when the rotational speed has been adjusted, the notification processing section 15 increments the count value of the number of times of adjustment of the rotational speed by one (S21). Further, the notification processing section 15 determines whether or not the count value has reached a threshold value (S23).

If the count value has not reached the threshold value, the process proceeds to S27. If the count value has reached the threshold value, the notification processing section 15 executes notification processing (S25).

In the S27, the exposure controller 13 adjusts the writing timing of the laser of the exposure device 43 by the first timing adjustment value based on the rotational speed adjustment.

Furthermore, the exposure controller 13 adjusts the writing timing of the laser of the exposure device 43 by the second timing adjustment value based on the phase matching.

Next, the registration processing section 14 performs the regist processing after the rotational speed adjustment (S29). That is, the registration processing section 14 forms the determination mark 109 on the belt B in each color, and the sensor 101 and 104 Perform reading.

Then, the registration processing section 14 detects the color misregistration of each color in the main scanning direction S and the sub-scanning direction F based on the reading result of the determination mark 109 of each color.

Furthermore, the registration processing section 14 controls the timings of writing and emission of laser of the exposure device 43 on the basis of the detection result to correct the color misregistration.

In the S31, the controller 10 waits in a state in which image formation is possible (S31), and ends the drum drive control.

In this state, when image data is acquired from the scanner section 3 or the communication I/E120, the controller 10 performs image formation.

Further, in a case where the drum drive control has been executed between pages of a print job, image formation of the next page is resumed.

### Technical Effects of Embodiment

In the image forming apparatus 1, the detection processing section 11 detects the outer peripheral speed fluctuation cycle of the drum 41 of each color in cooperation with the image forming section 4 and the sensor 101 to 104.

Furthermore, in the image forming apparatus 1, the drum drive controller 12 adjusts the rotational speed of the drum 41 so that a difference in outer peripheral speed fluctuation cycle among the drums 41 for the respective colors falls within a predetermined range.

Thus, the image forming apparatus 1 suppresses the color misregistration due to the difference in the outer peripheral speed fluctuation cycle among the drums 41 of the respective colors, thereby improving the image quality of the formed image.

In addition, the drum drive controller 12 controls the drum driver of each color to adjust the difference in the outer peripheral speed fluctuation cycle in the drum 41 of each color within a predetermined range. As a result, the image forming apparatus 1 can quickly and smoothly adjust the difference between the outer peripheral speed fluctuation cycles of the drums 41 of the respective colors within the predetermined range.

In addition, the drum drive controller 12 adjusts the rotational speed of the drum 41 so that the difference between the outer peripheral speed fluctuation cycle of the drum 41 and the cycle at the target rotational speed is within a predetermined range. As a result, the rotational speed of the drum 41 after the adjustment of each color can be converged to a speed that does not deviate from the target rotational speed. Therefore, it becomes possible to maintain the image forming apparatus 1 in a state close to an initially scheduled driving state, and it becomes possible to perform satisfactory image formation.

Furthermore, the drum drive controller 12 monitors an outer peripheral speed fluctuation cycle of the drum 41 of each color detected by the detection processing section 11. Then, the drum drive controller 12 determines an increase and a decrease in the rotational speed of the drum 41 of each color, and adjusts the difference in the outer peripheral speed fluctuation cycle in the drum 41 of each color within a predetermined range. That is, the drum drive controller 12 can easily and quickly adjust the difference between the outer peripheral speed fluctuation cycles of the drums 41 of the respective colors to be within the predetermined range by increasing or decreasing the rotational speeds of the drums 41.

The image forming apparatus 1 includes an encoder 413 for detecting the phase for the drum 41 of each color. Next, the drum drive controller 12 sets a target value of the output of the encoder 413, and adjusts the rotational speed of the drum of each color by feedback control.

Therefore, the image forming apparatus 1 can stably and accurately adjust the difference between the outer peripheral speed fluctuation cycles of the drums 41 of the respective colors within a predetermined range.

Further, the drum drive controller 12 determines the target value from the difference between the outer peripheral speed fluctuation cycles of the drums 41 of the respective colors obtained from the detection processing section 11. The difference in the outer peripheral speed fluctuation cycle may be a difference between the drums 41 of the respective colors or a difference between the outer peripheral speed fluctuation cycle of the drum 41 of each color and the cycle of the target rotational speed of the drum 41.

Thus, the target value of the encoder 413 can be appropriately set, and the difference in outer peripheral speed fluctuation cycle among the drums 41 of the respective colors can be effectively adjusted to fall within a predetermined range.

In addition, the drum drive controller 12 performs phase matching of the outer peripheral speed fluctuation cycles after the adjustment of the outer peripheral speed fluctuation cycles of the drums of the respective colors. Thus, the drum 41 of each color is driven in a state where the phase substantially coincides with the outer peripheral speed fluctuation cycle. Therefore, the image forming apparatus 1 can suppress the color misregistration due to the difference in the outer peripheral speed fluctuation cycle and the phase in the drum 41 of each color, and improve the image quality of the formed image.

The drum drive controller 12 also performs phase matching of the outer peripheral speed fluctuation cycles on the basis of the output of the encoder 413 of the drum 41 for each color. Thus, the phases of the outer peripheral speed fluctuation cycles of the drums 41 for the respective colors are more accuracy matched. Therefore, the image forming apparatus 1 can suppress the color misregistration due to the difference in the outer peripheral speed fluctuation cycle and the phase in the drum 41 of each color, and further improve the image quality of the formed image.

In addition, the drum drive controller 12 performs phase matching by matching the phases of nodes or antinodes in the cyclic outer peripheral speed fluctuation of the outer periphery of the drum 41 of each color. For this reason, the phases of the outer peripheral speed fluctuation cycles of the drums 41 of the respective colors are more appropriately matched. Therefore, the image forming apparatus 1 can suppress the color misregistration due to the difference in the outer peripheral speed fluctuation cycle and the phase in the drum 41 of each color, and further improve the image quality of the formed image.

The image forming apparatus 1 includes the exposure controller 13 that adjusts the writing timing of the laser that performs exposure in accordance with the adjustment of the rotational speed of the drum 41. For this reason, even when the rotational speed of the drum 41 is adjusted, the laser writing is appropriately performed, so that it is possible to maintain the formed image with high image quality.

In addition, the exposure controller 13 adjusts the laser writing timing in accordance with the phase matching of the drum 41. For this reason, at the time of the phase matching of the drum 41, the laser writing is properly effected, so that the formed image can be maintained at a higher image quality.

The image forming apparatus 1 includes the registration processing section 14 that executes color registration adjustment after the adjustment of the rotational speed of the drum 41 by the drum drive controller 12.

As a result, the image forming apparatus 1 can execute the color registration adjustment in a state in which the influence of the outer peripheral speed fluctuation of the drum 41 of each color and the fluctuation of the outer peripheral speed fluctuation cycle is suppressed. Therefore, it becomes possible to perform color registration adjustment in a state where color misregistration due to a peculiar factor such as a difference in cycle of the outer peripheral speed fluctuation of each drum 41 is suppressed. Thus, the image quality of the formed image can be improved.

The image forming apparatus 1 includes the notification processing section 15 that executes notification processing when the number of times of adjustment of the rotational speed of the drum 41 for each color by the drum drive controller 12 reaches a predetermined number of times.

As a result, it is possible to notify the user that the occurrence of wear or deterioration of the drum 41 over time is estimated. Then, when the drum 41 is replaced, a new drum 41 in which the fluctuation of the outer peripheral speed fluctuation cycle is unlikely to occur is used. Therefore, it is possible to improve the image quality of the formed image.

Furthermore, after the adjustment of the rotational speed for causing the difference between the outer peripheral speed fluctuation cycles of the respective drums 41 to fall within the predetermined range, the controller 10 rechecks the outer peripheral speed fluctuation cycle of each drum 41.

Therefore, the image forming apparatus 1 can perform readjustment in a case where the outer peripheral speed fluctuation cycles of the drums 41 are not sufficiently aligned. Thus, the image forming apparatus 1 can perform image formation in a more appropriate state.

In addition, the drum drive controller 12 adjusts the rotational speed of the drum 41 for each color so that the difference between the outer peripheral speed fluctuation cycles of the drums 41 falls within a predetermined range when a print job is not executed or between pages. Therefore, it is possible to adjust the difference between the outer peripheral speed fluctuation cycles of the respective drums 41 within a predetermined range by using a cycle in which the image forming apparatus 1 does not perform image formation. Thus, it is possible to maintain high image quality while maintaining high operation efficiency of the image forming apparatus 1.

In addition, the image forming apparatus 1 includes a lubricant applying mechanism 49 which is provided along with the drum 41 of each color. Accordingly, it is possible to reduce the binding force from the belt B with respect to each drum 41. Therefore, the lubricant application mechanism 49 and the adjustment of setting the difference in outer peripheral speed fluctuation cycle among the drums 41 of the respective colors within a predetermined range can be used in combination. Therefore, the image forming apparatus 1 can suppress the fluctuation in the outer peripheral speed fluctuation cycle of the drum 41 of each color over a long cycle of time.

### Others

The embodiment of the present disclosure has been described above. However, the present disclosure is not limited to the above-described embodiment. For example, in the embodiment, a constituent element integrally formed of a single member may be replaced with a constituent element divided into a plurality of members and connected or fixed to each other. In addition, a constituent element configured by connecting a plurality of members may be replaced with a constituent element integrally formed by a single member. In addition, the details described in the embodiment can be appropriately changed without departing from the spirit of the disclosure.

For example, the determination marks 109 and the speed fluctuation detection patterns 121 for color registration correction are not limited to be formed on the belt B.

For example, the marks 109 and the patterns 121 may be formed on the sheet P and read by a sensor disposed in the conveyance route.

Furthermore, the forms of the determination marks 109 for color registration correction and the speed fluctuation detection patterns 121 are merely examples, and are not limited thereto. Other forms of marks or patterns that can obtain the same function as those described above may be used.

Furthermore, the phase of the outer peripheral speed fluctuation cycle in the drum 41 of each color is not limited to the case of being specified from the detection of the maximum value or the minimum value of the outer peripheral speed fluctuation. For example, the outer peripheral speed fluctuation cycle of the drum 41 is largely due to the eccentricity. Therefore, the phase at which the eccentricity becomes maximum or minimum may be measured in advance at the time of assembly of the drum 41, and a mark may be provided on the drum 41 to detect the phase of the outer peripheral speed fluctuation cycle.

Alternatively, the output of the encoder 413 indicating the phase at which the eccentricity is maximized or minimized may be stored in the storage section 6. In this case, the phase of the outer peripheral speed fluctuation cycle may be detected from the output of the encoder 413.

In addition, the encoder 413 is exemplified as a phase sensor which detects the phase of the drum 41, but the invention is not limited thereto. As the phase sensor, any well-known sensor capable of detecting the rotation angle and the rotation amount of the drum 41 can be used.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
image bearing members on which toner images in respective colors are individually formed correspondingly to a plurality of colors;
a belt that is disposed so as to face the image bearing members of the respective colors arranged along a conveyance direction and transfers a toner image obtained by superimposing the toner images of the respective colors onto a recording medium;
image bearing member drivers configured to individually drive the image bearing members of the respective colors;
a belt driver that conveys the belt; and
a hardware processor that:
detects outer peripheral speed fluctuation cycles in the image bearing members of the respective colors, and
adjusts rotational speeds of the image bearing members of the respective colors so that a difference between the outer peripheral speed fluctuation cycles in the image bearing members of the respective colors is within a predetermined range.

2. The image forming apparatus according to claim 1, wherein
the hardware processor controls the image bearing member drivers of the respective colors to adjust the difference between the outer peripheral speed fluctuation cycles in the image bearing members of the respective colors within the predetermined range.

3. The image forming apparatus according to claim 1, wherein
the hardware processor adjusts the rotational speeds of the image bearing members of the respective colors so as to adjust a difference between the outer peripheral speed fluctuation cycles of the image bearing members of the respective colors and a cycle at a target rotational speed of the image bearing members during image formation to be within a predetermined range.

4. The image forming apparatus according to claim 1, wherein
after adjusting the rotational speeds of the image bearing members of the respective colors to adjust the difference between the outer peripheral speed fluctuation cycles of the image bearing members of the respective colors within the predetermined range, the hardware processor match phases of the outer peripheral speed fluctuation cycles.

5. The image forming apparatus according to claim 4, further comprising phase sensors configured to detect phases for the image bearing members of the respective colors, wherein
the hardware processor performs phase matching of the outer peripheral speed fluctuation cycles in the image bearing members of the respective colors based on an output of the phase sensors of the image bearing members of the respective colors.

6. The image forming apparatus according to claim 4, wherein
the hardware processor performs phase matching of the outer peripheral speed fluctuation cycles in the image bearing members of the respective colors by matching node or antinode phases in cyclic outer peripheral speed fluctuations in the image bearing members of the respective colors.

7. The image forming apparatus according to claim 1, wherein
the hardware processor adjusts writing timing of a laser that performs exposure on the image bearing members of the respective colors in accordance with adjustment of the rotational speeds of the image bearing members of the respective colors that the hardware processor has done for adjusting the difference between the outer peripheral speed fluctuation cycles of the image bearing members of the respective colors within the predetermined range.

8. The image forming apparatus according to claim 1, wherein
after adjusting the rotational speeds of the image bearing members of the respective colors for adjusting the difference between the outer peripheral speed fluctuation cycles of the image bearing members of the respective colors within the predetermined range, the hardware processor checks the outer peripheral speed fluctuation cycles of the image bearing members of the respective colors.

9. The image forming apparatus according to claim 1, wherein
the hardware processor executes color registration adjustment after adjusting the rotational speeds of the image bearing members of the respective colors for adjusting the difference between the outer peripheral speed fluctuation cycles in the image bearing members of the respective colors within the predetermined range.

10. The image forming apparatus according to claim 1, further comprising phase sensors configured to detect phases for the image bearing members of the respective colors, wherein
the hardware processor sets a target value to be detected by the phase sensors, and adjusts the rotational speeds of the image bearing members of the respective colors by feedback control so that the difference between the outer peripheral speed fluctuation cycles of the image bearing members of the respective colors is within the predetermined range.

11. The image forming apparatus according to claim 10, wherein
the hardware processor determines the target value from the difference between the detected outer peripheral speed fluctuation cycles in the image bearing members of the respective colors.

12. The image forming apparatus according to claim 1, wherein
the hardware processor monitors the detected outer peripheral speed fluctuation cycles of the image bearing members of the respective colors, determines increase and decrease of the rotational speeds of the image bearing members of the respective colors, and adjusts the difference between the outer peripheral speed fluctuation cycles of the image bearing members of the respective colors within the predetermined range.

13. The image forming apparatus according to claim 1, wherein
the hardware processor executes adjustment of the rotational speeds of the image bearing members of the respective colors for adjusting the difference between the outer peripheral speed fluctuation cycles of the image bearing members of the respective colors within the predetermined range when a print job is not executed or between pages.

14. The image forming apparatus according to claim 1, further comprising
lubricant applicators provided along with the image bearing members of the respective colors.

15. The image forming apparatus according to claim 1, wherein
the hardware processor counts a number of times of execution of adjustment of the rotational speeds of the image bearing members of the respective colors for adjusting the difference between the outer peripheral speed fluctuation cycles of the image bearing members of the respective colors within the predetermined range, and executes notification processing when the number of times of execution reaches a predetermined number of times.

16. A control method of an image forming apparatus that includes: image bearing members on which toner images in respective colors are individually formed correspondingly to a plurality of colors; a belt that is disposed so as to face the image bearing members of the respective colors arranged along a conveyance direction and transfers a toner image obtained by superimposing the toner images of the respective colors onto a recording medium; image bearing member drivers configured to individually drive the image bearing members of the respective colors; a belt driver that conveys the belt; and a hardware processor that detects outer peripheral speed fluctuation cycles in the image bearing members of the respective colors, the method comprising
adjusting rotational speeds of the image bearing members of the respective colors so that a difference between the outer peripheral speed fluctuation cycles in the image bearing members of the respective colors is within a predetermined range.

17. A non-transitory computer-readable storage medium storing a control program for a computer that controls an image forming apparatus including: image bearing members on which toner images in respective colors are individually formed correspondingly to a plurality of colors; a belt that is disposed so as to face the image bearing members of the respective colors arranged along a conveyance direction and transfers a toner image obtained by superimposing the toner images of the respective colors onto a recording medium; image bearing member drivers configured to individually drive the image bearing members of the respective colors; a belt driver that conveys the belt; and a hardware processor that detects outer peripheral speed fluctuation cycles in the image bearing members of the respective colors, the program causing the computer to perform
adjusting rotational speeds of the image bearing members of the respective colors so that a difference between the outer peripheral speed fluctuation cycles in the image bearing members of the respective colors is within a predetermined range.
